(19) United States
(12) Patent Application Publication
(10) Pub. No.: US 2025/0364770 A1
(43) Pub. Date: Nov. 27, 2025

(54) Thulium-Doped Fiber Amplifier Including Redirection Of Residual Pump Energy

(71) Applicant: Cybel, LLC., Bethlehem, PA (US)

(72) Inventors: Jean-Marc Delavaux, Pittstown, NJ (US); Conrad Knight, Easton, PA (US)

(73) Assignee: Cybel, LLC., Bethlehem, PA (US)

(21) Appl. No.: 18/672,255

(22) Filed: May 23, 2024

(51) Int. Cl. H01S 3/094; H01S 3/067; H01S 3/16

(52) U.S. Cl. CPC H01S 3/094003; H01S 3/06716; H01S 3/1616

(57) ABSTRACT

An optical amplifying device based upon the use of Tm-doped optical fiber is proposed, and particularly configured to provide amplification of input signals operating in the wavelength range of 1700-1800 nm. A section of Tm-doped fiber less than a meter is used to provide amplification in the proposed wavelength range, and the amplifying device is specifically configured to direct unabsorbed pump energy away from the main signal path of the amplifying device, preventing damage to and/or degradations in the performance of the amplifying device.

### TECHNICAL FIELD

Disclosed herein is a Tm-doped fiber amplifier (which may also be used as a fiber laser) that enables management of unabsorbed energy when the amplifier is used with input signals within a wavelength range of about 1700-1800 nm.

### BACKGROUND OF THE INVENTION

Recent work in thulium-doped (Tm-doped) fiber amplifiers (TDFAs) demonstrates that these devices are capable of operation over a wide wavelength range spanning from about 1630 nm to more than 2100 nm. In particular, TDFAs that operate in the wavelength range of 1730-1800 nm are of interest because of rich molecular absorptions near 1730 nm and 1780 nm in CH₂, as well as other molecules that are significant for bio-photonics applications. Both continuous wave (CW) and pulsed operation modes of these TDFAs are considered as important for applications such as mid-IR frequency generation, Raman soliton generation in conventional optical fibers, direct detection and coherent communication, and quantum computing employing ¹³³Ba⁺ ions.

When considering the Tm ion emission spectrum, this wavelength range of interest (i.e., 1700-1800 nm) is on the short wavelength end of the emission spectrum and requires that the length of the Tm-doped fiber be kept relatively short to prevent the amplification of longer wavelengths within overall span of up to 2100 nm. It has been found that a fiber length on the order of less than one meter or so limits the possibility of these longer wavelengths being amplified. It is known, however, that the use of a relatively short length of Tm-doped fiber limits the possibility of full absorption of the pump power by the Tm ions, which results in excess pump power exiting the fiber and reduces optical efficiency. Excessive amounts of unabsorbed pump may damage other components in the optical system, such as isolators, multiplexers, and the like.

One approach to address this excess pump problem has been to increase the power level of the input signal, leading to a stronger saturation of the gain and absorption of a majority of the pump power. However, there are many situations where the power level of an optical input signal may be limited to only a few mW and cannot utilize this approach.

### SUMMARY OF THE INVENTION

The needs remaining in the art are addressed by the present invention, which relates to improving the stability and performance of Tm-doped fiber amplifiers used in the generation of high-gain optical signals within an input signal wavelength range of about 1700-1800 nm (i.e., the short wavelength portion within which Tm ion emission occurs). As will be described in detail below, it is proposed to provide management of the pump energy used to create amplification with the Tm-doped fiber in a manner that allows for high levels of output power to be achieved without damaging the components forming the amplifier itself. More particularly, it is proposed to direct unabsorbed pump energy out of the primary optical signal path to prevent further interaction between this residual pump and any components of the amplifier arrangement.

In particular, it is proposed to mitigate the presence of unabsorbed pump energy, which is present when using the relatively short lengths (i.e., less than one meter) of Tm-doped fiber required for optimum performance when the input signal is selected to operate within a range of about 1700-1800 nm. In one exemplary embodiment, a wavelength division multiplexer (WDM) is disposed in the amplifier's signal path at the location where the unabsorbed pump exits the Tm-doped fiber. The WDM is configured to demultiplex the pump wavelength with respect to the signal wavelength and thus direct any unabsorbed pump energy out of the signal path. In some cases, the pump energy exiting the WDM may be directed into a pump absorption component. In other cases, any unabsorbed pump energy may be redirected back into the pump signal path itself and used again for signal amplification. The latter approach is particularly well-suited when the TDFA is incorporated into a fiber laser ring topology.

An exemplary embodiment of the present invention may be configured as a single stage TDFA using single-clad Tm-doped fiber (either polarization-maintaining (PM) fiber or single-mode (SM) fiber). The input signal may be either CW or pulsed, depending on the application. The principles of unabsorbed pump energy redirection may be used in either a counter-propagating pump configuration or co-propagating pump configuration. Other embodiments may be configured as multi-stage arrangements (again, using PM or SM fiber; CW or pulsed operation) which may share a single pump source to operate all stages, or utilize individual pump sources for each stage. Different pump wavelengths may be used for each stage to assist in managing the presence of unabsorbed pump energy in accordance with the principles of the present invention.

With respect to the input signal range of interest, it has been found that Tm-doped fibers having a length no greater than about 0.8 m, and more particularly within the range 0.4-0.8 m, are best suited to minimize the unwanted amplification of any higher-wavelength (i.e., greater than 1800 nm) noise that may be present. Obviously, the shorter the length of the Tm-doped fiber, the larger amount of unabsorbed pump energy that may interfere with the operation of the TDFA if not managed in accordance with the principles of the present invention.

One embodiment of the present invention may take the form of a Tm-doped optical amplifying device for use with an input signal operating in the wavelength range λ_{S} of 1700-1800 nm. As configured, this embodiment includes a section of Tm-doped optical fiber (defined as having a first termination and second, opposing termination) having a length L less than one meter, a pump source generating a pump beam at a wavelength μ_{P} known to excite Tm ions within the section of Tm-doped optical fiber, an input coupler disposed between the pump source and the first termination of the section of Tm-doped optical fiber and configured to inject the pump beam into the section of Tm-doped optical fiber and provide amplification to the input optical signal propagating therethrough, and a pump redirection coupler disposed at the second, opposing termination of the section of Tm-doped optical fiber and configured to direct an unabsorbed pump beam exiting the section of Tm-doped optical fiber away from a path of the propagating input signal.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a diagram of an exemplary Tm-doped fiber amplifier (TDFA) formed in accordance with the present invention, using a counter-propagating pump input to the TDFA;

FIG. 2 is a diagram of an exemplary TDFA similar to that of FIG. 1, but in this configuration using a co-propagating pump input to the TDFA;

FIG. 3 is a graph including plots of unabsorbed pump power as a function of launched pump power for two different sets of input signal conditions;

FIG. 4 contains a plot showing the dependence of signal output power as a function of pump wavelength, also showing the change in the amount of unabsorbed pump energy as a function of pump wavelength;

FIG. 5 is a diagram of an exemplary two-stage TDFA formed in accordance with the principles of the present invention;

FIG. 6 is a graph containing plots associated with the operating of the second stage of the two-stage TDFA of FIG. 5, showing the changes in signal output power and unabsorbed pump as a function of the launched pump power;

FIG. 7 is a plot illustrating the effect of pump wavelength on the unabsorbed pump power for the second stage of the configuration of FIG. 5;

FIG. 8 depicts another embodiment of a two-stage TDFA formed in accordance with the principles of the present invention, in this case utilizing amplification of the pump beam prior to entering each stage;

FIG. 9 illustrates an exemplary three-stage TDFA formed in accordance with the present invention;

FIG. 10 shows a TDFA formed in accordance with the present invention as incorporated within a fiber ring laser configuration; and

FIG. 11 illustrates an alternative embodiment of the TDFA fiber ring laser shown in FIG. 10, in this case utilizing polarization beam splitters (PBSs) in place of wavelength division multiplexers/demultiplexers (WDMs).

### DETAILED DESCRIPTION

FIG. 1 is a diagram of an exemplary Tm-doped fiber amplifier 10 (TDFA 10) that is formed in accordance with the principles of the present invention to manage the presence of unabsorbed pump power. TDFA 10 is shown as comprising a length of single-clad Tm-doped fiber (TDF) 12, which may be formed of either polarization-maintaining (PM) fiber or single-mode (SM) fiber. An applied input signal Sᵢₙ is shown as passing through an input isolator 14 before it is applied as an input to TDF 12. In this particular example, Sᵢₙ is depicted as operating at a wavelength λ_{S}=1762 nm, a wavelength within the wavelength range of interest for emerging applications (i.e., the wavelength range of about 1700-1800 nm, as mentioned above). In order to limit the ability of longer wavelengths beyond this range to be amplified, TDF 12 is configured to have a relatively short length L (in comparison to conventional Tm-doped fiber amplifiers) of less than one meter, and preferably within the range of about 0.4-0.8 m. It is this need to use a relatively short length of Tm-doped fiber for efficient amplification of short-wavelength input signals that creates the problem of unabsorbed pump energy addressed by the present invention.

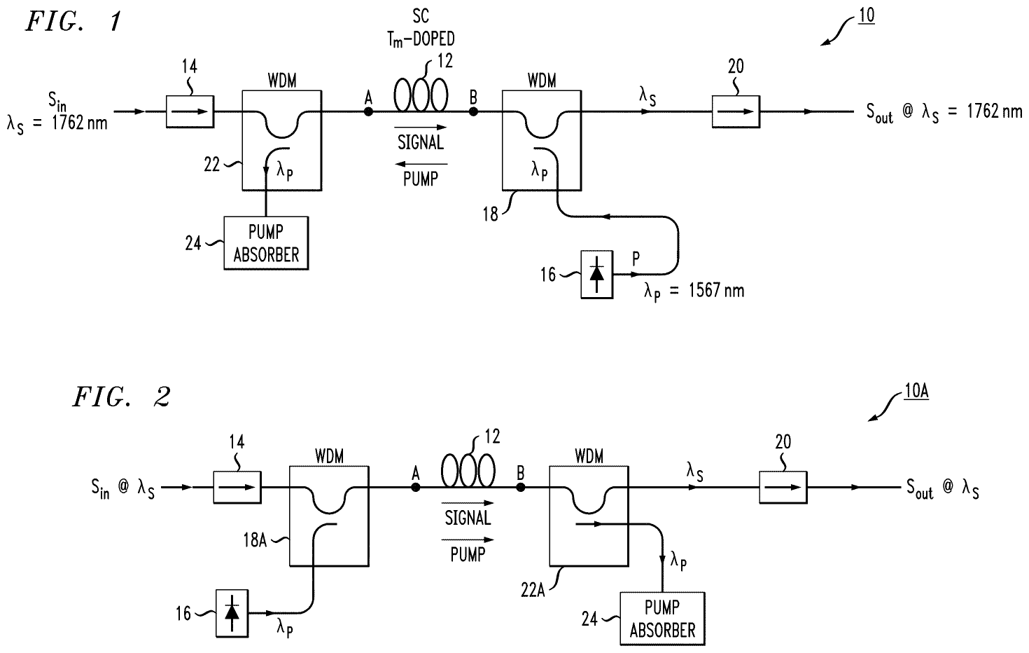

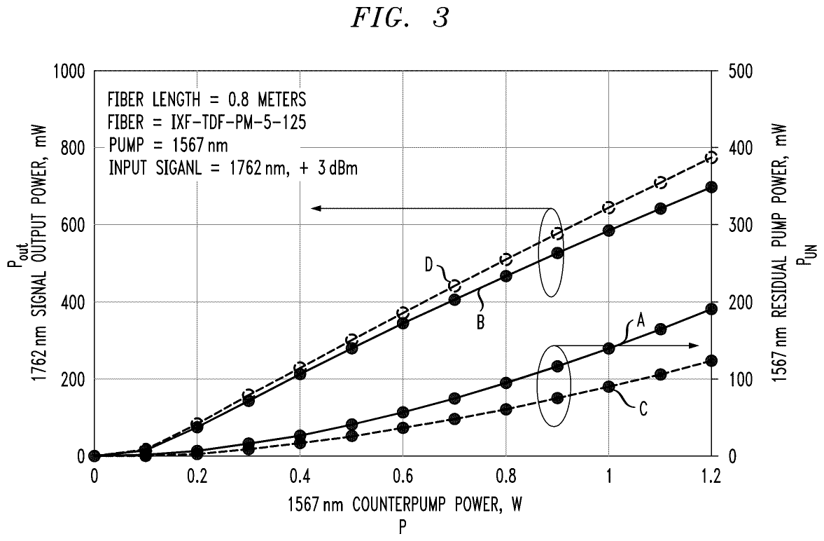

TDFA 10 is shown in this case as taking the form of a counter-pumped amplifier, using a pump source 16 disposed beyond the output of TDF 12. A co-pumped configuration of a TDFA formed in accordance with the present invention is discussed below in association with FIG. 2. Continuing with the discussion of TDFA 10 of FIG. 1, pump source 16 itself may comprise a semiconductor laser, an amplified laser source, a fiber-based laser, or any other configuration capable of providing a pump beam at a wavelength λ_{P} known to interact with Tm ions. In use, pump source 16 provides a pump beam P at a wavelength μ_{P} selected to amplify input signal Sᵢₙ by excitation of the Tm ions within TDF 12 (for example, selecting μ_{P} from within the range of about 1540-1600 nm). In this example, a pump wavelength μ_{P} of 1567 nm is chosen. A first WDM 18 is positioned at the output of TDF 12 and used to introduce pump beam P in a counter-propagating direction to TDF 12. First WDM 18 (which may be described at times hereafter as a “pump input WDM”, or simply “input WDM”) is further configured to allow for the amplified version of Sᵢₙ (defined as Sₒᵤₜ and continuing to propagate at λ_{S} of 1762 nm) to be directed through an output isolator 20 and thereafter exit as the amplified output signal Sₒᵤₜ from TDFA 10.

In accordance with the principles of the present invention, TDFA 10 further comprises an arrangement to manage the presence of unabsorbed pump energy that exits TDF 12. In the counter-propagating configuration of FIG. 1, unabsorbed pump energy will exit TDF 12 along an “input” termination A; that is, the termination which receives optical signal Sᵢₙ as an input. With reference to FIG. 1, if some sort of pump power management is not used, the unabsorbed pump power exiting along termination A of TDF 12 will be directed into input isolator 14. If a relatively large level of pump power remains, it may be strong enough to damage input isolator 14 and degrade the performance of TDFA 10.

Thus, in accordance with this embodiment of the present invention, TDFA 10 is configured to include a second WDM 22 that is positioned between input isolator 14 and input termination A of TDF 12. Second WDM 22 (which may be described at times in the following discussion as a “pump redirection WDM”) is configured to demultiplex pump wavelength μ_{P} with respect to signal wavelength λ_{S}, directing the remaining pump energy into an excess pump absorber element 24. An example embodiment of second WDM 22 is able to separate λ_{S} and μ_{P} with minimal insertion loss (e.g., on the order of about 0.3 dB) and crosstalk (e.g., 30 dB) between the two wavelengths, thus allowing input signal Sᵢₙ to propagate through second WDM 22 with little or no loss. In one embodiment, excess pump absorber element 24 may comprise a passive configuration of an epoxy-coated metal structure (for example, an aluminum block) that absorbs the pump light. The specifics of the absorber design are not considered as relevant, with other designs and materials also suitable for use.

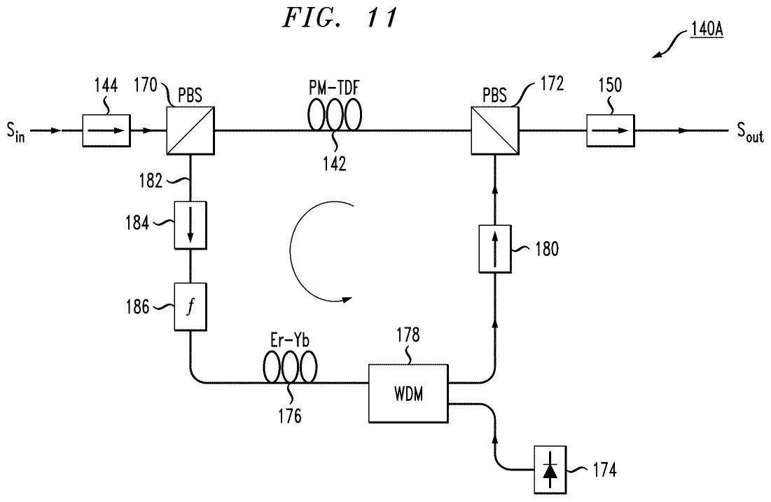

Other amplifier configurations that redirect unabsorbed pump away from the primary signal path are also contemplated as falling within the scope of the present invention. For example, various other embodiments may be configured to re-use the remaining pump light in combination with light from a pump source to provide input signal amplification, as discussed below in association with FIGS. 10 and 11.

As mentioned above, the principles of the present invention also apply to TDFAs that are configured to use a co-propagating pump source. FIG. 2 illustrates a TDFA 10A similar to TDFA 10 of FIG. 1, but in this case a first (input) WDM 18A is shown as disposed at termination A of TDF 12 and functions to multiplex the input signal Sᵢₙ operating at λ_{S} and the pump beam P operating at μ_{P} onto a common input optical path to TDF 12. In this co-propagating configuration, any unabsorbed pump power exits TDF 12 along with amplified optical signal Sₒᵤₜ. A second (pump redirection) WDM 22A is shown as disposed beyond the output of TDF 12 and functions to demultiplex the unabsorbed pump energy at μ_{P} from the amplified signal Sₒᵤₜ propagating at wavelength λ_{S}. As with the configuration of FIG. 1, the unabsorbed pump energy is thereafter directed into excess pump absorber element 24.

Recall that various emerging applications are seeking a TDFA that functions within the wavelength band of about 1700-1800 nm. Since the gain fiber suitable for amplifying this wavelength band is limited in length to less than one meter (preferably, in the range 0.4-0.8 m) for signal integrity purposes, the levels of unabsorbed pump energy in TDFAs exiting short-length sections of Tm-doped fiber are not insignificant and illustrate the need for ensuring that the unabsorbed pump does not impair the performance of the TDFA.

FIG. 3 contains plots of unabsorbed pump power (PUN) as a function of launched pump power for two sets of input conditions within this input signal wavelength range of interest. A first plot, labeled A in FIG. 3, is a plot of PUN (measured in mW) as a function of total pump input power (measured in W) for a pump beam operating at λ_{P}=1567 nm and used to amplify an input signal Sᵢₙ operating at a “wavelength of interest” λ_{S} of 1762 nm, with an input power Pᵢₙ of 2 mW (3 dBm). For the sake of completeness, the signal output power Pₒᵤₜ associated with this same range of launched pump power is shown as plot B in FIG. 3. A second plot of unabsorbed pump energy PUN (identified as plot C in FIG. 3) is associated with a higher input signal power, in this case, Pᵢₙ=4 mW (6 dBm). The signal output power Pₒᵤₜ for this higher-power input is shown in plot D in FIG. 3. The maximum launched pump power was 1.2 W in both cases, and the Tm-doped fiber used to generate this data was a polarization-maintaining, single-clad Tm-doped fiber having a length of 0.8 meters, with the amplifier configured in the counter-propagation configuration shown in FIG. 1.

In reviewing plot A, it is shown that the amount of unabsorbed pump power continuously increases as the launched pump power increases, rising to a level of about 16% of the launched power for a pump operating at 1.2 W. As discussed above, one prior art approach to mitigating unabsorbed pump power is to increase the power of the input signal, allowing for more of the pump energy to be absorbed within the short length of Tm-doped fiber. This is evident from reviewing plot C (associated with the higher input signal power) with respect to plot A. The reduced amount of unabsorbed pump shown in plot C is about 10% of the launched power when using a 1.2 W pump input. While somewhat less, a level of 10% unabsorbed pump may be more than enough to damage the performance of the TDFA.

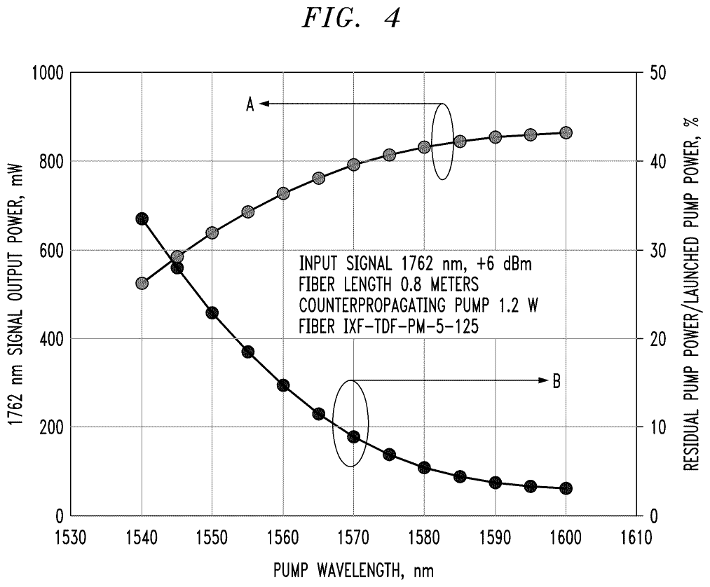

Another approach to reducing the level of unabsorbed pump is to use a higher wavelength pump beam, which leads to higher signal gain/output power. FIG. 4 illustrates the dependence of signal output power Pₒᵤₜ as a function of pump wavelength. As with the parameters of FIG. 3, the input signal Sᵢₙ was selected to have an operating wavelength λ_{S} of 1762 nm, with an input power Pᵢₙ of 4 mW. Plot A illustrates the increase in signal output power Pₒᵤₜ as the pump wavelength μ_{P} is increased from about 1540 nm to about 1600 nm. The percentage of unabsorbed pump as a function of pump wavelength is shown in curve B. Pump beam P was maintained at a launch power of 1.2 W and tuned to span the wavelength range for μ_{P} from 1540-1600 nm. It is clear from a study of FIG. 4 that an increase in pump wavelength μ_{P} increases pump absorption within the Tm-doped fiber and, therefore, decreases the amount of unabsorbed pump energy (particularly when considered as a percentage of the launched pump power). Plot A shows the increase in signal output power from about 500 mW to over 800 mW across the pump wavelength range of interest.

Thus, this increase in Pₒᵤₜ as a function of pump wavelength results in lowering the amount of unabsorbed pump power exiting the fiber, as shown in plot B, which plots the percentage of unabsorbed pump as a function of launched pump. For example, the percentage of unabsorbed pump is about 15% at λ_{P}=1560 nm, and then drops to a percentage of about 5% for λ_{P}=1580 nm. The signal output power Pₒᵤₜ increases from 720 mW to 820 mW for these two pump wavelengths.

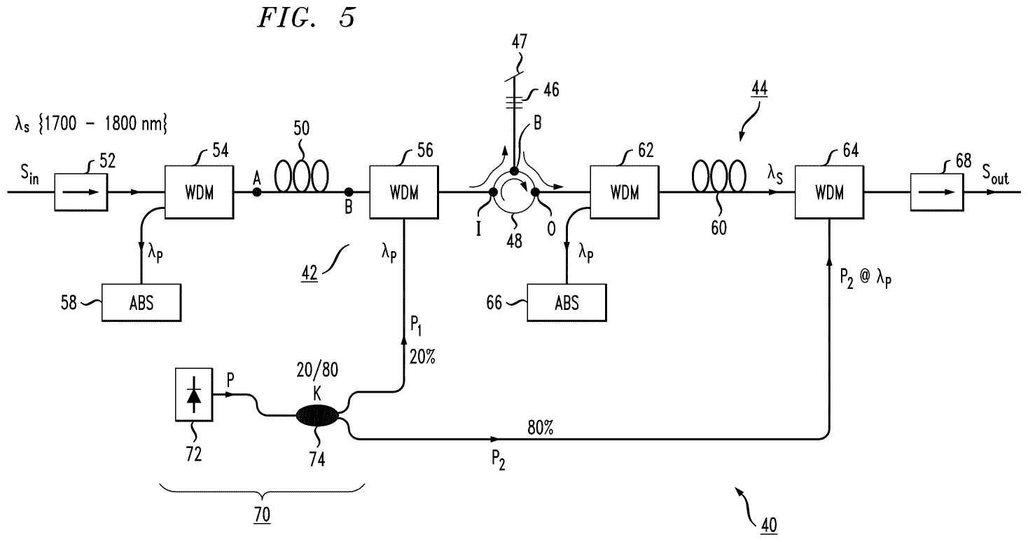

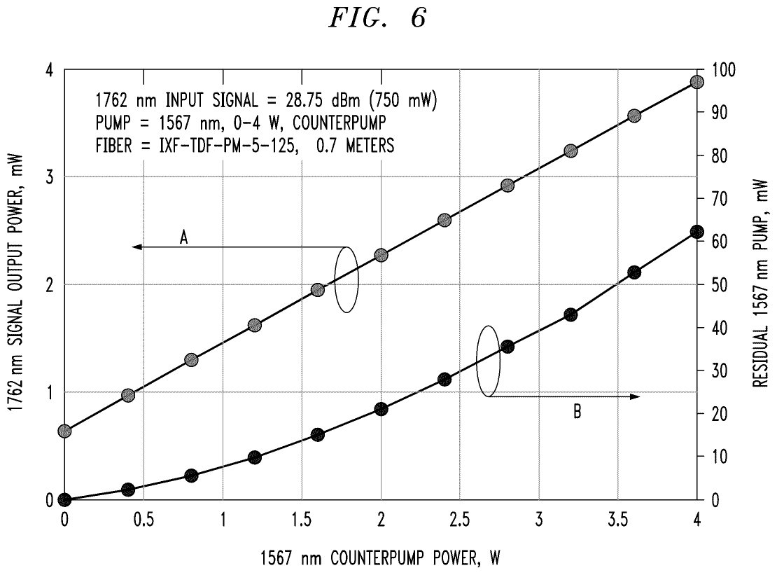

FIG. 5 is a diagram of an exemplary two-stage TDFA 40 using the same excess pump absorption principles as discussed above in association with TDFA 10 of FIG. 1 and TDFA 10A of FIG. 2. In particular TDFA 40 is shown as comprising a first stage 42 (which may be used as a preamplifier) and a second stage 44 (which may be used as a power booster), where in this particular example both stages 42 and 44 are shown as implementing a counter-propagating pump configuration. Again, this configuration is considered as exemplary only, with arrangements using co-propagating pump beams being acceptable as well. Additionally, it is to be understood that first stage 42 may use a co-propagating pump beam and second stage 44 may use a counter-propagating pump beam (or vice versa), depending on the application.

A bandpass reflection filter 46 is shown in FIG. 5 as positioned between first stage 42 and second stage 44, with filter 46 centered at the signal wavelength of λ_{S} and used to minimize the amount of spurious noise and ASE (generated within first stage 42) that is introduce to second amplifier stage 44. In this particular embodiment, a three-port optical circulator 48 is disposed in the signal path between first stage 42 and second stage 44, with bandpass filter 46 coupled to the bi-directional port B of circulator 48. With this arrangement, the amplified output signal from first stage 42 is coupled to the input port I of circulator 48, where it propagates through to exit at bi-directional port B and pass through bandpass filter 46. As shown, filter 46 is terminated by a reflector 47, which directs the filtered signal to pass a second time through filter 46 and re-enter bi-directional port B. The filtered signal propagates through optical circulator 48 and ultimately exits at output port O, which is coupled to the input of second stage 44.

Continuing with reference to FIG. 5, first stage 42 is shown as including a short section of Tm-doped fiber, denoted as TDF 50, with an input signal Sᵢₙ passing through an input isolator 52 and a pump redirection WDM 54 before entering TDF 50. Again, it is to be understood that the “short section” of Tm-doped fiber used to amplify signals within the wavelength range of 1700-1800 nm is configured to have a length less than one meter, and preferably in the range of about 0.4-0.8 m. In this example, input signal Sᵢₙ is identified as operating at a signal wavelength λ_{S} of 1762 nm. It is to be understood that this particular value for λ_{S} is exemplary only, with the advantages of pump management in accordance with the present invention useful for input signals operating across a wavelength range of about 1700 nm-1800 nm (at times referred to as a Tm-excited short wavelength region).

As with the arrangement of FIG. 1, a counter-propagating pump configuration is used to inject a pump beam operating at a suitable wavelength μ_{P} into first amplifier stage 42 in this specific embodiment. In particular, a first pump beam P₁ is introduced into an output termination B of TDF 50 via an input WDM 56 so as to propagate in a direction counter to input signal Sᵢₙ. In accordance with the principles of the present invention, the excess pump energy exiting TDF 50 at termination A is thereafter redirected by a pump redirection WDM 54 into an excess pump absorber element 58. Second stage 44 has similar components; namely, a short section of TDF 60, a pump redirection WDM 62, an input WDM 64, and an excess pump absorber element 66. An output isolator 68 is shown as positioned beyond the output of second stage 44, with the signal exiting output isolator 68 defined as power-boosted output signal Sₒᵤₜ of two-stage TDFA 40.

In this particular embodiment, a pump source 70 is configured to be shared between first stage 42 and second stage 44. Here, pump source 70 includes a light source 72 (such as a distributed feedback laser (DFB), for example) for generating a pump beam P at a desired wavelength μ_{P}. In order to be used with both amplifier stages, pump beam P is first passed through a power splitter 74 which functions to direct a first fraction (power percentage) P₁ of the pump beam toward first stage 42 and a second, remaining power fraction P₂ toward second stage 44. In one application where first stage 42 is used as a preamplifier and second stage 44 is used as a power booster, power splitter 74 is configured to direct a higher power pump into the power boosting second stage 44 (since increasing the pump power is known to increase the amount of amplification, as shown in FIG. 3). In one example, power splitter 74 may be configured as a 20/80 splitter with first pump beam P₁ being about 20% of the launched pump power, with the remaining 80% used as P₂ for the second (power booster) stage power booster 44.

It has been found that even when the percentages of pump power are particularly configured for a specific purpose (e.g., preamplifier vs. power booster), when used with the relatively short lengths of Tm-doped fiber (i.e., lengths less than one meter) required for input signals in the range of about 1700 nm-1800 nm, a significant amount of unabsorbed pump energy is present in each stage. Therefore, the inclusion of excess pump absorber elements 58 and 66, in accordance with the principles of the present invention, provides the desired management of residual pump energy in a manner that prevents damage to individual components within the amplifier, or the performance of the amplifier itself.

In other embodiments of the present invention, separate pump sources may be used for each stage, with perhaps different pump wavelengths used for each stage. That is, a preamplifer first stage 42 may use a longer pump wavelength (e.g., 1580 nm) to generate a higher level of pump absorption in the presence of a relatively low-power input signal (i.e., on the order of a few mW). Inasmuch as preamplifier first stage 42 generates an amplified output signal at a level sufficient to saturate TDF 60 of power booster second stage 44, the choice of a specific pump wavelength is not a significant concern.

FIG. 6 contains plots associated with the arrangement of FIG. 5, in particular with respect to the operation of power boosting second stage 44, plotting the changes in output power and unabsorbed pump as a function of the pump power that is launched into second stage 44. In generating these plots, the input signal applied to second stage 44 (i.e., the output from first stage 42) exhibits a power level of about 750 mW, and TDF 60 comprised a section of Tm-doped PM fiber having a length of about 0.7 meters A first plot A shows the increase in optical signal output power (Pₒᵤₜ) as the pump power increases (up to a maximum of 4 W). The unabsorbed pump power associated with second stage 44 (shown in plot B) is seen to increase from about 10 mW to over 60 mW when the pump power launched into second stage 44 reaches a level of 4 W. While somewhat less than the unabsorbed pump associated with first stage 42, it is still significant and may damage circulator 48, as well as other components in the transmission path. Thus, the inclusion of excess pump absorber element 66 in accordance with the principles of the present invention is contemplated as being of great importance in terms of redirect this residual pump energy away from the primary signal path and the various components forming the TDFA.

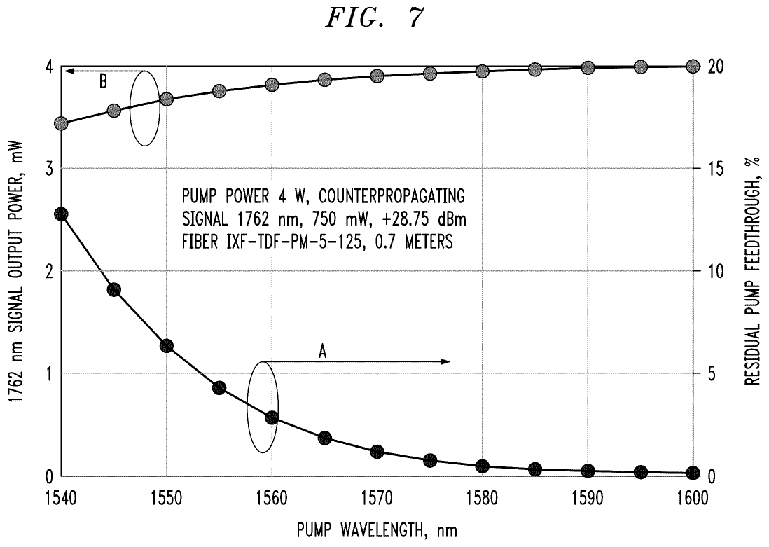

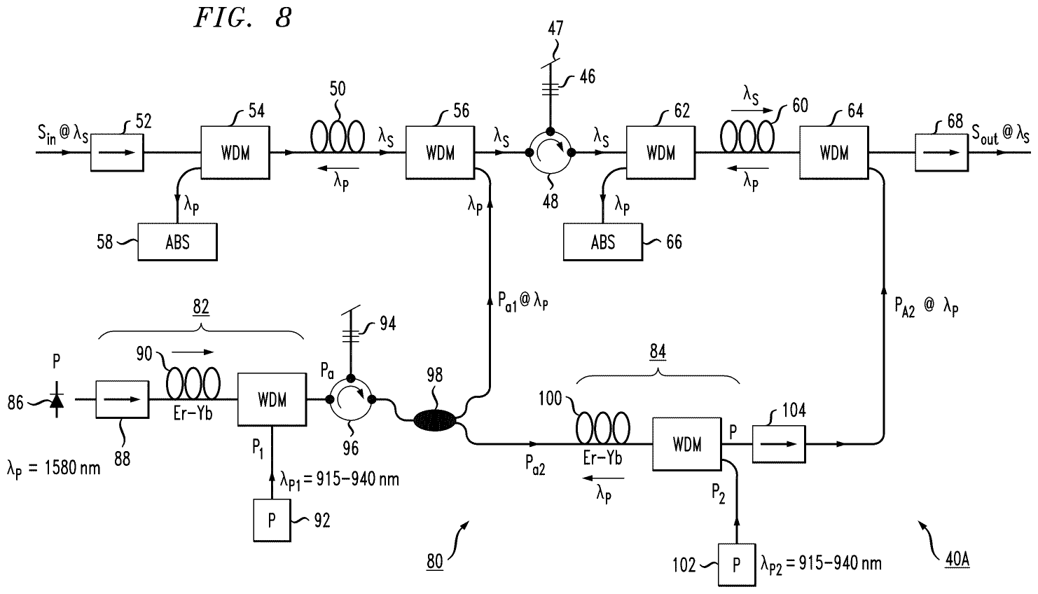

FIG. 7 looks at the effect of pump wavelength μ_{P} on residual pump (plot A) and signal gain (plot B) for power boosting second stage 44 of TDFA 40. The unabsorbed pump shown in plot A is presented as a fraction of the launched power, where a constant pump power of 4 W was used for each of the different wavelengths of μ_{P}. The data presented here confirms that when second (booster) stage 44 uses a longer wavelength pump (i.e., up to λ_{P}=1600 nm), the percentage of unabsorbed pump is reduced. Advantageously, the longer wavelength pump also increases the output signal power, as evident in plot B, resulting in a better optical conversion efficiency than that associated with a shorter wavelength pump.

In some example embodiments, a pump source for a multi-stage amplifier of the present invention may be configured as a distributed master oscillator amplifier (MOPA) in order to deliver optimum levels of pump power to both preamplifier stage 42 and power boosting stage 44. FIG. 8 illustrates an exemplary two-stage TDFA 40A that utilizes the same preamplifier and power booster configurations as TDFA 40 of FIG. 5, but shows a particular configuration of a MOPA pump source 80 that provides an additional level of signal amplification beyond that achieved with a conventional laser pump source. In this particular configuration of the present invention, a pair of Er—Yb fiber amplifiers 82, 84 is used in combination with a DFB laser 86 (or similar type of input pump beam source) to generate a relatively high power pump beam P and control the power levels of the individual pumps P₁ and P₂ applied to each stage.

DFB laser 86 is depicted in FIG. 8 as providing an initial pump beam operating at a wavelength μ_{P} of 1580 nm (in this example). The output from DFB laser 86 is first passed through an isolator 88 before being applied as an input to Er—Yb fiber amplifier 82, particularly coupled into a section of Er—Yb co-doped fiber 90. A first pump source 92 is used to generate a first pump beam p₁ that is also applied as an input to Er—Yb co-doped fiber 90 and thus provide amplification of initial pump beam, generating an amplified pump beam Pa at the output of first pump amplification 82. In association with the use of Er—Yb co-doped fiber, first pump beam p₁ operates at a wavelength λₚ₁ in the range of about 915-940 nm. For the particular configuration of pump source 80, the amplified pump beam Pₐ exiting first Er—Yb amplifier 82 passes through a reflective bandpass filter 94 (controlled by an included three-port optical circulator 96) to remove any ASE or noise that may be present before being applied as an input to a pump power splitter 98.

A first fraction of amplified pump beam Pₐ (denoted as Pₐ₁) is shown as directed by pump power splitter 98 toward preamplifier stage 42, with the remaining, second fraction Pₐ₂ of amplified pump beam Pₐ directed toward power boosting stage 44. In particular, pump beam Pₐ₁ is directly coupled to pump input WDM 56 of preamplifier stage 42. In contrast, pump beam Paz is first passed through second Er—Yb fiber amplifier 84 to receive additional amplification before being coupled to input WDM 64 of power boosting stage 44. As shown with respect to second Er—Yb fiber amplifier 84, pump beam Paz is coupled into a section of Er—Yb co-doped fiber 100 forming amplifier 84. A second pump beam p₂ (from a pump source 102) operating at an appropriate wavelength λ for generating gain in the presence of the Er and Yb ions (again typically in the range of about 915-940 nm) is injected as a counter-propagating pump beam p₂ to second input to Er—Yb co-doped fiber 100.

The amplified pump output beam from Er—Yb co-doped fiber 100 (denoted as P_{A2} in FIG. 8) is shown as first passing through an isolator 104 before being applied as the pump beam input to WDM 64 of power booster stage 44 of TDFA 40A. By virtue of including fiber amplifiers 82, 84 within pump source 80, it is possible to efficiently generate a multi-Watt pump beam as an input to power booster stage 44. As discussed above, the ability to provide a multi-Watt pump beam allows for the generation of a high-power output signal Sₒᵤₜ from TDFA 40A, where the inclusion of excess pump absorber element 66 allows for the residual pump power (which may be relatively high in this case) to be directed away from the primary optical signal path. Otherwise, without the use of excess pump absorber element 66, the presence of relatively high-power residual pump could impact the operation of circulator 48, as well as preamplifier stage 42 of TDFA 40A.

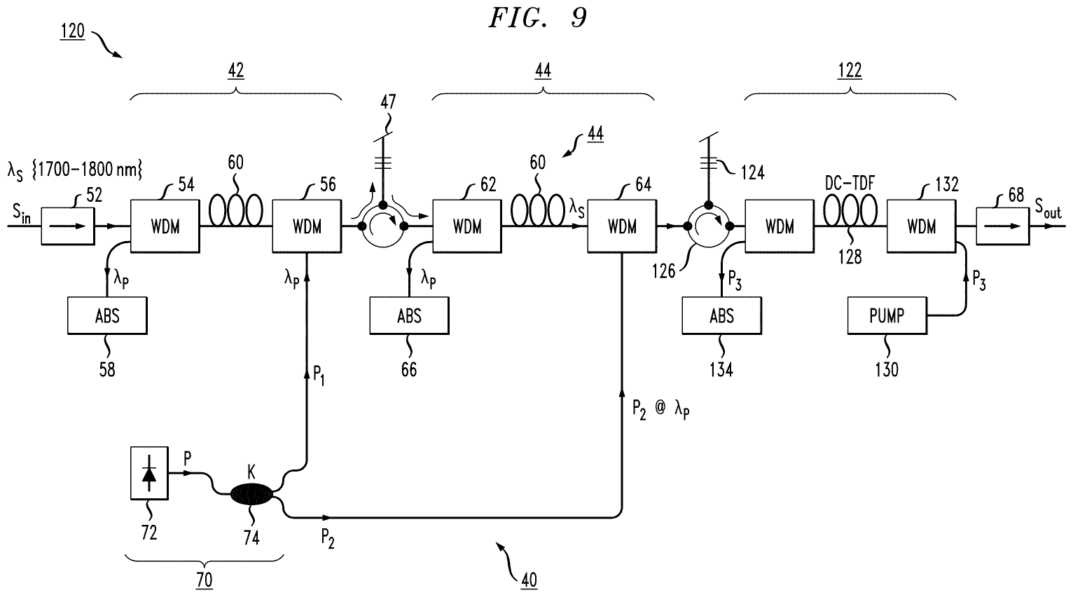

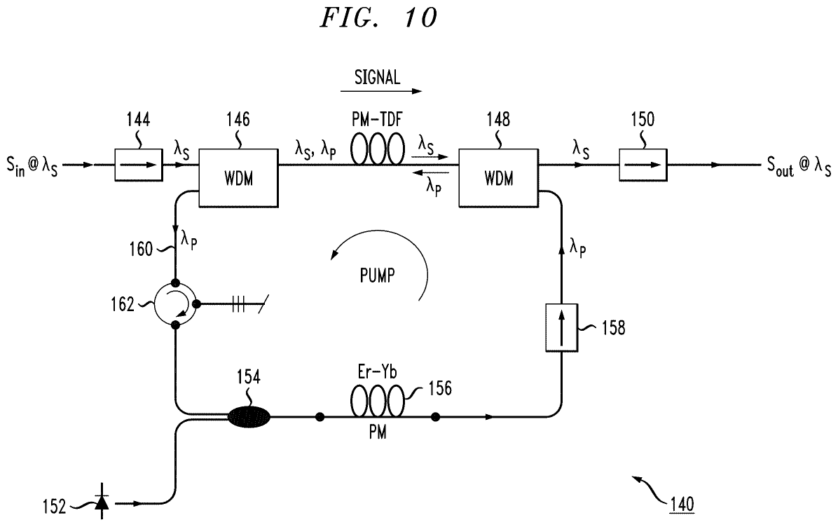

Another embodiment of the present invention that is configured to create a multi-Watt output signal Sₒᵤₜ while continuing to manage the presence of residual pump energy is shown in FIG. 9. In particular, a TDFA 120 is shown as taking the form of a three-stage amplifier, with an additional power amplifier stage 122 being added to two-stage TDFA 40 of FIG. 5. Indeed, the same reference numerals as found in FIG. 5 are used to identify the elements of the first two stages of TDFA 120. Inasmuch as the operation of this portion of TDFA 120 is the same as that described above, it will not be repeated here.

Preferably, a narrowband reflective filter 124 is included at the interface between power boosting stage 44 and power amplifier stage 122 to minimize the amount of noise and ASE that is introduced to this final stage of the amplifier configuration. Again, an optical circulator 126 may be used to control the propagation of the amplified output signal Sₒᵤₜ from power boosting stage 44 through filter 124 and thereafter applied as an input to power amplifier 122.

Power amplifier 122 is shown as including a relatively short length of Tm-doped fiber 128 (TDF 128), which in this case may be configured to have a relatively large core area (for example, a core diameter on order of about 20 μm, as opposed to standard single mode fiber with a core region diameter of about 8 μm). While TDF 128 may comprise a single-clad optical fiber (as used in preamplifier stage 42 and power boosting stage 44), it may be preferred to utilize a double-clad (DC) optical fiber. Again, only the core region of the DC fiber is formed to include the Tm dopant. The use of a DC fiber may be preferred for applications where it is known that the power scaling is to be on the order of tens of Watts. With the double-clad fiber, the use of a pump stripper may be a viable alternative to removing the unabsorbed pump energy. Another approach may be to use a higher-index coating in the splice between TDF 128 and the output of circulator 126 to remove the excess pump.

Continuing with the description of power amplifier 122, a separate pump source 130 is shown as supplying a pump beam P₃ to TDF 128 via an included WDM 132. Pump source 130 may take the form of a discrete laser source, for example a multimode device operating at a pump wavelength λ_{P3} of 783 nm. An included excess pump absorber element 134 is disposed at input termination A of TDF 128 and used to direct remaining pump energy away from the system. In configurations where TDF 128 is based on the use of DC fiber, pump absorber element 134 may take the form of a pump stripper or high-index splice coating (for example) as mentioned above. That is, when using a DC fiber, a majority of the residual pump will be present in the outer cladding, and a pump stripper may be configured to be directly coupled to this cladding layer.

Since power amplifier 122 is strongly saturated by the power generated within stages 42 and 44, it is possible to eliminate the use of interstage filtering; that is, elements 124 and 126 may be considered as optional.

It is to be recalled that another option for managing the presence of unabsorbed pump energy involves the re-use of any residual pump for the signal amplification process. FIGS. 10 and 11 illustrate two embodiments of a TDFA formed in accordance with this aspect of the present invention. The TDFAs as shown in these figures are included as part of a fiber ring laser that allows for any residual pump energy to be redirected through a pump amplification element and then passed again through the TDFA.

FIG. 10 shows an exemplary TDFA 140 that is incorporated within a fiber ring laser configuration. Similar to the arrangements described above, TDFA 140 includes a relatively short section (i.e., less than one meter) of Tm-doped fiber (TDF 142). In accordance with the principles of operation for a ring laser, the polarization properties of the optical signal and pump beam are required to maintain a defined polarization state. Therefore, TDF 142 is formed of a section of polarization-maintaining (PM) optical fiber that is also Tm-doped. An applied input signal Sᵢₙ first passes through an input isolator 144 (formed as a PM component) and a pump redirection WDM 146 (again, a PM component) before being applied as an input to TDF 142. The amplified output signal Sₒᵤₜ from TDF 124 subsequently passes through a pump input WDM 148 and an output isolator 150 before exiting TDFA 140 as an amplified optical signal. Again, it is to be understood that both WDM 148 and isolator 150 are configured as PM components.

Continuing with reference to FIG. 10, a pump source 152 is used to supply a polarization-controlled pump beam operating at an appropriate wavelength μ_{P} for the ring structure, where it first passes through an optical combiner 154 before entering an Er—Yb co-doped fiber amplifier, shown here as comprising a section of PM Er—Yb co-doped fiber 156. The amplified pump output Pₒᵤₜ is shown as passing through an optical isolator 158 before being introduced to pump input WDM 148. In the ring architecture, optical isolator 158 prevents any reflected pump energy from propagating in a counter direction around the ring. In a typical fashion, the counter-propagating pump beam Pₒᵤₜ provides amplification of the applied input signal Sᵢₙ to create output signal Sₒᵤₜ of TDFA 140.

In accordance with this particular embodiment of the present invention, the unabsorbed pump energy PUN that exits at termination A of PM-TDF 142 is demultiplexed by WDM 146 to be coupled into a section of PM fiber 160 and propagates therealong until reaching a three-port optical circulator 162, where PUN is coupled to the input port I of optical circulator 162. Unabsorbed pump energy PUN thereafter travels through optical circulator 162 until reaching bi-directional port B. A reflective narrowband filter 164 centered at pump wavelength μ_{P} is coupled to bi-directional port B, allowing for PUN to make two passes through filter 164 to minimize the presence of out-of-band noise and ASE that may be present prior to re-using the unabsorbed pump. The filtered version of unabsorbed pump energy PUN is re-introduced to optical circulator 162 at bi-directional port B and propagates through circulator 162 to exit at output port O and is subsequently applied as an input to optical combiner 154. This residual pump then combines with the primary beam generated by source 152 and continues to function as a counter-propagating pump input to PM-TDF 142.

In this manner, TDFA 140 can be thought of as comprising a linear signal path supporting the amplification of an applied optical input signal Sᵢₙ (i.e., moving from left to right in the illustration of FIG. 10), and a circular (ring) signal path supporting the continuous propagation of the pump beam P in a counter-clockwise signal path (indicated by the arrow) around the ring structure. The linear state of polarization (SOP) of the linear signal path may be either collinear with the SOP of the pump's ring structure, or fixed to be orthogonal thereto.

FIG. 11 depicts another configuration of the fiber ring laser embodiment of the present invention (denoted as TDFA 140A). Similar to TDFA 140 as shown in FIG. 10, a linear signal path is used to support the propagation of an applied input signal Sᵢₙ through input isolator 144, PM-TDF 142, and output isolator 150. The presence of a pump beam within PM-TDF 142 is used in a conventional manner to generate amplification of input signal Sᵢₙ, providing an amplified version as the output signal Sₒᵤₜ of TDFA 140A. Also similarly, an applied pump beam propagates around a ring structure that allows for unabsorbed pump energy PUN to be filtered and re-used.

With reference to FIG. 11, it is shown that the PM WDM components 146, 148 have been replaced by polarization beam splitters (PBS). In particular, a first PBS 170 is positioned at termination A of PM-TDF 142 and a second PBS 172 is positioned at termination B of PM-TDF 142. The use of polarization beam splitters forces the SOP of the ring structure associated with propagation of the pump beam to be orthogonal to the SOP of the applied input signal that is being amplified within PM-TDF 142. By maintaining this orthogonal relationship, any unabsorbed pump energy will be directed away from the propagating input signal Sᵢₙ by the properties of PBS 170.

Similar to the arrangement of FIG. 10, a pump source 174 is used to provide an input pump beam P, which in this embodiment is used as a counter-propagating pump input to a PM Er—Yb amplifier 176. In particular, a PM WDM 178 is used to couple the pump input to Er—Yb amplifier 176, and demultiplex the amplified output from Er—Yb amplifier 176 (denoted as Pₒᵤₜ) to continue to circulate around the pump path. As further shown in FIG. 11, Pₒᵤₜ then passes through a PM isolator 180 before being applied as an input to PBS 172. The optical signal paths within TDFA 140A all comprise PM fiber, which is configured to maintain the SOP of the circulating pump energy to be orthogonal to the linear transmission path of the optical signal. Therefore, when polarization pump beam Pₒᵤₜ reaches second PBS 172, it is directed into PM-TDF 142 as a counter-propagating pump beam. As mentioned above, the presence of PBS 170 forces any unabsorbed pump energy PUN along a pump path 182 so as to pass through a PM isolator 184 and filtered by a PM in-line optical filter 186. As shown, the filtered version of PUN (which maintains the defined SOP for the pump beam) is applied as the “signal” input to Er—Yb amplifier 176, where it is amplified by counter-propagating pump P to generate amplified pump beam Pₒᵤₜ.

While certain preferred embodiments of the present invention have been illustrated and described in detail, it should be apparent that modifications and adaptations to these embodiments may occur to one skilled in the art without departing from the scope of the present invention as set forth in the claims appended hereto. Indeed, the described embodiments are to be considered in all respects as only illustrative and not restrictive.

What is claimed is:

1. A Tm-doped optical amplifying device for use with an input signal operating in the wavelength range λ_{S} of 1700-1800 nm, comprising:
a section of Tm-doped optical fiber, defined as having a first termination and second, opposing termination, the section of Tm-doped optical fiber having a length L less than one meter;
a pump source generating a pump beam at a wavelength μ_{P} known to excite Tm ions within the section of Tm-doped optical fiber;
an input coupler disposed between the pump source and the first termination of the section of Tm-doped optical fiber and configured to inject the pump beam into the section of Tm-doped optical fiber and provide amplification to the input optical signal propagating therethrough; and
a pump redirection coupler disposed at the second, opposing termination of the section of Tm-doped optical fiber and configured to direct an unabsorbed pump beam exiting the section of Tm-doped optical fiber away from a path of the propagating input signal.

2. The Tm-doped optical amplifying device as defined in claim 1, further comprising
an excess pump absorber element configured to received the unabsorbed pump beam from the pump redirection coupler.

3. The Tm-doped optical amplifying device as defined in claim 2, wherein the excess pump absorber element comprises an epoxy-coated metal component.

4. The Tm-doped optical amplifying device as defined in claim 1, wherein the input coupler comprises a first WDM configured to multiplex/demultiplex wavelengths λ_{S} and μ_{P} and the pump redirection coupler comprises a second WDM configured to multiplex/demultiplex wavelengths λ_{S} and μ_{P}.

5. The Tm-doped optical amplifying device as defined in claim 1, wherein the Tm-doped optical amplifying device comprises a single stage Tm-doped fiber amplifier (TDFA) configured as a counter-propagating amplifier, wherein the input signal passes through the pump redirection coupler prior to entering the section of Tm-doped fiber and the input coupler is disposed beyond the section of Tm-doped optical fiber and configured to direct the pump beam into the section of Tm-doped fiber so as to propagate through in a direction opposite to the propagation direction of the input signal, with unabsorbed pump energy exiting the section of Tm-doped optical fiber so as to be coupled into the pump redirection coupler.

6. The Tm-doped optical amplifying device as defined in claim 1, wherein the Tm-doped optical amplifying device comprises a single stage Tm-doped fiber amplifier (TDFA) configured as a co-propagating amplifier, wherein the input signal and the pump beam are applied as separate inputs to the input coupler, the combination thereafter injected into the section of Tm-doped fiber, with the pump redirection coupler being disposed beyond the section of Tm-doped optical fiber and configured to direct unabsorbed pump energy away from the TDFA.

7. The Tm-doped optical amplifying device as defined in claim 1, wherein the Tm-doped optical amplifying device comprises a multi-stage amplifier including at least a first amplifier stage and a second amplifier stage, each of the first and second amplifier stages comprising:
a section of Tm-doped optical fiber, defined as having a first termination and second, opposing termination, the section of Tm-doped optical fiber having a length L less than one meter;
a pump source generating a pump beam at a wavelength μ_{P} known to excite Tm ions within the section of Tm-doped optical fiber;
an input coupler disposed between the pump source and the first termination of the section of Tm-doped optical fiber and configured to inject the pump beam into the section of Tm-doped optical fiber and provide amplification to the input optical signal propagating therethrough; and
a pump redirection coupler disposed at the second, opposing termination of the section of Tm-doped optical fiber and configured to direct an unabsorbed pump beam exiting the section of Tm-doped optical fiber away from a path of the propagating input signal.

8. The Tm-doped optical amplifying device as defined in claim 7 wherein the pump source of the first amplifier stage and the pump source of the second amplifier stage are configured as two separate pump sources.

9. The Tm-doped optical amplifying device as defined in claim 8 wherein the pump wavelength of the first amplifier stage pump source is greater than the pump wavelength of the second amplifier stage pump source.

10. The Tm-doped optical amplifying device as defined in claim 7 wherein the pump source of the first amplifier stage and the pump source of the second amplifier stage are configured as a single pump supply, the single pump supply comprising
a laser light source for generating an initial pump beam having a known input pump power; and
a power splitter coupled to the output of the laser light source, the power splitter configured to direct a first portion of the known input pump power into the first amplifier stage as the pump source of the first amplifier stage, and direct a second, remaining portion of the known input pump power into the second amplifier stage as the pump source of the second amplifier stage.

11. The Tm-doped optical amplifying device as defined in claim 1, configured as a fiber ring laser and further comprising a pump recycling path coupled between the output of the pump redirection coupler and the input of the input coupler, comprising:
a laser light source for generating an initial pump beam;
a power combiner responsive to the unabsorbed pump and the initial pump beam for creating a pump input lightwave;
a fiber amplifier disposed beyond the output of the power combiner and responsive to the pump input lightwave to creating an amplified pump lightwave;
an optical isolator disposed between the output of the fiber amplifier and the input coupler; and
an optical bandpass filter centered at AP and disposed along the pump recycling path between the output of the pump redirection coupler and the power combiner, wherein each element of the fiber ring laser is formed as a polarization-maintaining element.

12. The Tm-doped optical amplifying device as defined in claim 11, wherein the optical bandpass filter comprises
a three-port optical circulator formed to include an input port, a bi-directional port, and an output port, wherein unabsorbed pump exiting the pump redirection coupler is directed into the input port and a filtered version of the unabsorbed pump exits along the output port of the three-port optical circulator; and
a reflective bandpass filter coupled to the bi-directional port of the three-port optical circulator.

13. The Tm-doped optical amplifying device as defined in claim 12 wherein the input coupler comprises a first polarization-maintaining WDM and the pump redirection coupler comprises a second polarization-maintaining WDM.

14. The Tm-doped optical amplifying device as defined in claim 12 wherein the input coupler comprises a first polarization beam splitter and the pump redirection coupler comprises a second polarization beam splitter, wherein the polarization state of the input signal Sᵢₙ is maintained as orthogonal to the polarization stage of the pump beam.
